(19) United States
(12) Patent Application Publication
(10) Pub. No.: US 2023/0141380 A1
(43) Pub. Date: May 11, 2023

(54) METHOD AND APPARATUS FOR SIDELINK RESOURCE RE-EVALUATION

(71) Applicant: Lenovo (Beijing) Ltd., Beijing (CN)

(72) Inventors: Xiaodong Yu, HAIDIAN DISTRICT (CN); Zhennian Sun, CHAOYANG DISTRICT (CN); Haipeng Lei, Haidian District (CN); Xin Guo, CHAOYANG DISTRICT (CN)

(73) Assignee: Lenovo (Beijing) Ltd., Beijing (CN)

(21) Appl. No.: 17/913,338

(22) PCT Filed: Mar. 24, 2020
(86) PCT No.: PCT/CN2020/080912

§ 371 Date: Sep. 21, 2022

(51) Int. Cl. H04W 72/40

(52) U.S. Cl. CPC H04W 72/40

(57) ABSTRACT

Embodiments of the present application are related to a method and apparatus for sidelink resource re-evaluation of a user equipment (UE) supporting 3GPP (3rd Generation Partnership Project) 5G new radio (NR). A method for sidelink communications performed by a UE includes: receiving configuration information for a partial sensing window; receiving configuration information for a resource re-evaluation sensing window; determining the resource re-evaluation sensing window based on the configuration information or the partial sensing window and the configuration information for the resource re-evaluation sensing window; and performing a resource re-evaluation procedure during the resource re-evaluation sensing window.

### TECHNICAL FIELD

Embodiments of the present application generally relate to wireless communication technology, especially to a method and an apparatus for sidelink resource re-evaluation under 3GPP (3rd Generation Partnership Project) 5G new radio (NR).

### BACKGROUND

Vehicle to everything (V2X) has been introduced into 5G wireless communication technology. In terms of a channel structure of V2X communication, the direct link between two user equipments (UEs) is called a sidelink. Sidelink is a long-term evolution (LTE) feature introduced in 3GPP Release 12, and enables a direct communication between proximal UEs, and data does not need to go through a base station (BS) or a core network.

5G and/or NR networks are expected to increase network throughput, coverage, and robustness and reduce latency and power consumption. With the development of 5G and NR networks, various aspects need to be studied and developed to perfect the 5G/NR technology.

### SUMMARY

Some embodiments of the present application provide a method for sidelink communications performed by a user equipment (UE). The method includes: receiving configuration information for a partial sensing window; receiving configuration information for a resource re-evaluation sensing window; determining the resource re-evaluation sensing window based on the configuration information for the partial sensing window and the configuration information for the resource re-evaluation sensing window; and performing a resource re-evaluation procedure during the resource re-evaluation sensing window.

Some embodiments of the present application provide an apparatus. The apparatus includes: a non-transitory computer-readable medium having stored thereon computer-executable instructions, a receiving circuitry; a transmitting circuitry; and a processor coupled to the non-transitory computer-readable medium, the receiving circuitry and the transmitting circuitry, wherein the computer-executable instructions cause the processor to implement the abovementioned method for sidelink communications performed by a UE.

Some embodiments of the present application provide a method for sidelink communications performed by a base station (BS). The method includes: transmitting configuration information for a partial sensing window; and transmitting configuration information for a resource re-evaluation sensing window, wherein the configuration information for the partial sensing window and the configuration information for the resource re-evaluation sensing window are used for determining the resource re-evaluation sensing window.

Some embodiments of the present application provide an apparatus. The apparatus includes: a non-transitory computer-readable medium having stored thereon computer-executable instructions, a receiving circuitry; a transmitting circuitry; and a processor coupled to the non-transitory computer-readable medium, the receiving circuitry and the transmitting circuitry, wherein the computer-executable instructions cause the processor to implement the abovementioned method for sidelink communications performed by a BS.

The details of one or more examples are set forth in the accompanying drawings and the description below. Other features, objects, and advantages will be apparent from the description and drawings, and from the claims.

### BRIEF DESCRIPTION OF THE DRAWINGS

In order to describe the manner in which advantages and features of the application can be obtained, a description of the application is rendered by reference to specific embodiments thereof, which are illustrated in the appended drawings. These drawings depict only example embodiments of the application and are not therefore to be considered limiting of its scope.

FIG. 1 illustrates an exemplary V2X communication system in accordance with some embodiments of the present application;

FIG. 2 illustrates an exemplary partial sensing procedure in accordance with some embodiments of the present application;

FIG. 3 illustrates a further exemplary partial sensing procedure in accordance with some embodiments of the present application;

FIG. 4 illustrates an exemplary flow chart of performing a partial sensing procedure in accordance with some embodiments of the present application;

FIG. 5 illustrates an exemplary flow chart of a method for performing a resource re-evaluation procedure in accordance with some embodiments of the present application;

FIG. 6 illustrates another exemplary partial sensing procedure in accordance with some embodiments of the present application;

FIG. 7 illustrates an additional exemplary partial sensing procedure in accordance with some embodiments of the present application;

FIG. 8 illustrates an exemplary resource re-evaluation procedure in accordance with some embodiments of the present application;

FIG. 9 illustrates a further exemplary resource re-evaluation procedure in accordance with some embodiments of the present application;

FIG. 10 illustrates an exemplary resource selection procedure in accordance with some embodiments of the present application;

FIG. 11 illustrates an exemplary resource transmission procedure in accordance with some embodiments of the present application;

FIG. 12 illustrates a further exemplary flow chart of a method for wireless communication in accordance with some embodiments of the present application; and

FIG. 13 illustrates a block diagram of an exemplary apparatus in accordance with some embodiments of the present application.

### DETAILED DESCRIPTION

The detailed description of the appended drawings is intended as a description of preferred embodiments of the present application and is not intended to represent the only form in which the present application may be practiced. It should be understood that the same or equivalent functions may be accomplished by different embodiments that are intended to be encompassed within the spirit and scope of the present application.

Reference will now be made in detail to some embodiments of the present application, examples of which are illustrated in the accompanying drawings. Embodiments of the present application may be provided in a network architecture that adopts various service scenarios, for example but is not limited to, 3GPP 3G, long-term evolution (LTE), LTE-Advanced (LTE-A), 3GPP 4G, 3GPP 5G NR (new radio), 3GPP LTE Release 12 and onwards, etc. It is contemplated that along with the 3GPP and related communication technology development, the terminologies recited in the present application may change, which should not affect the principle of the present application.

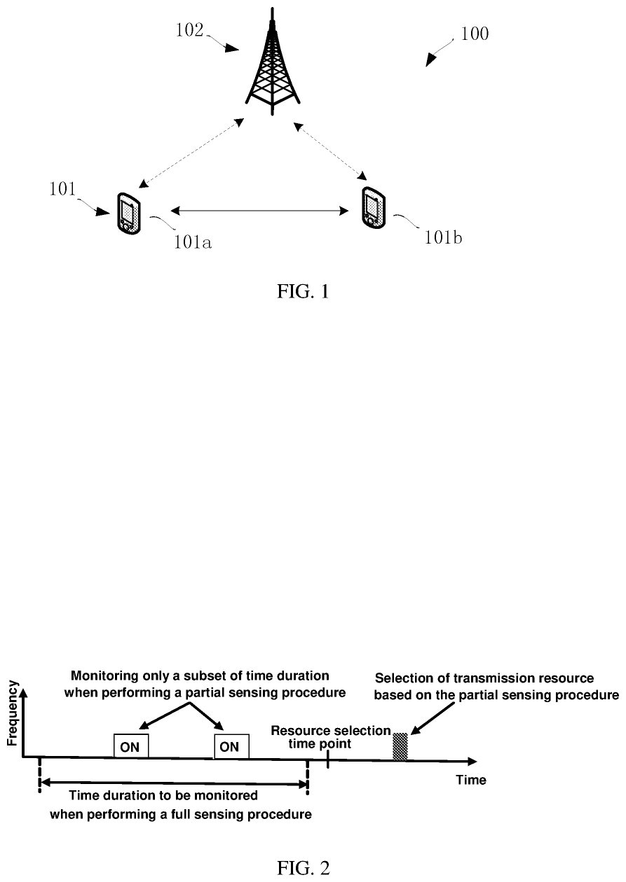

FIG. 1 illustrates an exemplary V2X communication system in accordance with some embodiments of the present application.

As shown in FIG. 1, a wireless communication system 100 includes at least one user equipment (UE) 101 and at least one base station (BS) 102. In particular, the wireless communication system 100 includes two UEs 101 (e.g., UE 101a and UE 101b) and one BS 102 for illustrative purpose. Although a specific number of UEs 101 and BS 102 are depicted in FIG. 1, it is contemplated that any number of UEs 101 and BSs 102 may be included in the wireless communication system 100.

The UE(s) 101 may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like. According to some embodiments of the present application, the UE(s) 101 may include a portable wireless communication device, a smart phone, a cellular telephone, a flip phone, a device having a subscriber identity module, a personal computer, a selective call receiver, or any other device that is capable of sending and receiving communication signals on a wireless network.

In some embodiments of the present application, UE is pedestrian UE (P-UE or PUE) or cyclist UE. In some embodiments of the present application, the UE(s) 101 includes wearable devices, such as smart watches, fitness bands, optical head-mounted displays, or the like. Moreover, the UE(s) 101 may be referred to as a subscriber unit, a mobile, a mobile station, a user, a terminal, a mobile terminal, a wireless terminal, a fixed terminal, a subscriber station, a user terminal, or a device, or described using other terminology used in the art. The UE(s) 101 may communicate directly with BSs 102 via LTE or NR Uu interface.

In some embodiments of the present application, each of the UE(s) 101 may be deployed an IoT application, an eMBB application and/or a URLLC application. For instance, UE 101a may implement an IoT application and may be named as an IoT UE, while UE 101b may implement an eMBB application and/or a URLLC application and may be named as an eMBB UE, an URLLC UE, or an eMBB/URLLC UE. It is contemplated that the specific type of application(s) deployed in the UE(s) 101 may be varied and not limited.

According to some embodiments of FIG. 1, UE 101a functions as Tx UE, and UE 101b functions as Rx UE. UE 101a may exchange V2X messages with UE 101b through a sidelink, for example, PC5 interface as defined in 3GPP TS 23.303. UE 101a may transmit information or data to other UE(s) within the V2X communication system, through sidelink unicast, sidelink groupcast, or sidelink broadcast. For instance, UE 101a transmits data to UE 101b in a sidelink unicast session. UE 101a may transmit data to UE 101b and other UEs in a groupcast group (not shown in FIG. 1) by a sidelink groupcast transmission session. Also, UE 101a may transmit data to UE 101b and other UEs (not shown in FIG. 1) by a sidelink broadcast transmission session.

Alternatively, according to some other embodiments of FIG. 1, UE 101b functions as Tx UE and transmits V2X messages, UE 101a functions as Rx UE and receives the V2X messages from UE 101b.

Both UE 101a and UE 101b in the embodiments of FIG. 1 may transmit information to BS 102 and receive control information from BS 102, for example, via LTE or NR Uu interface. The BS(s) 102 may be distributed over a geographic region. In certain embodiments of the present application, each of the BS(s) 102 may also be referred to as an access point, an access terminal, a base, a base unit, a macro cell, a Node-B, an evolved Node B (eNB), a gNB, a Home Node-B, a relay node, or a device, or described using other terminology used in the art. The BS(s) 102 is generally a part of a radio access network that may include one or more controllers communicably coupled to one or more corresponding BS(s) 102.

The wireless communication system 100 may be compatible with any type of network that is capable of sending and receiving wireless communication signals. For example, the wireless communication system 100 is compatible with a wireless communication network, a cellular telephone network, a Time Division Multiple Access (TDMA)-based network, a Code Division Multiple Access (CDMA)-based network, an Orthogonal Frequency Division Multiple Access (OFDMA)-based network, an LTE network, a 3GPP-based network, a 3GPP 5G network, a satellite communications network, a high altitude platform network, and/or other communications networks.

In some embodiments of the present application, the wireless communication system 100 is compatible with the 5G NR of the 3GPP protocol, wherein BS(s) 102 transmit data using an OFDM modulation scheme on the downlink (DL) and the UE(s) 101 transmit data on the uplink (UL) using a Discrete Fourier Transform-Spread-Orthogonal Frequency Division Multiplexing (DFT-S-OFDM) or cyclic prefix-OFDM (CP-OFDM) scheme. More generally, however, the wireless communication system 100 may implement some other open or proprietary communication protocols, for example, WiMAX, among other protocols.

In some embodiments of the present application, the BS(s) 102 may communicate using other communication protocols, such as the IEEE 802.11 family of wireless communication protocols. Further, in some embodiments of the present application, the BS(s) 102 may communicate over licensed spectrums, whereas in other embodiments, the BS(s) 102 may communicate over unlicensed spectrums. The present application is not intended to be limited to the implementation of any particular wireless communication system architecture or protocol. In yet some embodiments of present application, the BS(s) 102 may communicate with the UE(s) 101 using the 3GPP 5G protocols.

In 3GPP standard document TS36.300 [2], the design related to partial sensing for UE (e.g., PUE) is as follows. For each transmission pool, a partial sensing based selection mechanism, which is allowed to be used in this transmission pool, is also configured. A partial sensing based selection mechanism may also be named as a partial sensing based resource selection mechanism, a partial sensing mechanism, a partial sensing procedure, or the like.

A PUE which supports sidelink reception can be configured or pre-configured to perform a partial sensing procedure. In the partial sensing procedure, only a subset of subframes in a full sensing window has to be monitored by UE (e.g., PUE). A PUE may choose how few subframes it wishes to monitor, by trading off the reliability of its transmissions with the power saving, subject to monitoring a configured or pre-configured minimum number of partial sensing window(s). Configuration information or pre-configuration information can also set how far into the past a partial sensing window extends, and can require a PUE to perform a partial sensing procedure in a number of these truncated sensing window(s). Compared with a full sensing procedure, a partial sensing procedure can achieve power saving to a certain extent.

FIG. 2 illustrates an exemplary partial sensing procedure in accordance with some embodiments of the present application.

Specifically, FIG. 2 shows time duration for performing a full sensing procedure and a partial sensing procedure in time and frequency domains. When performing a partial sensing procedure, a PUE (e.g., UE 101a or UE 101b illustrated and shown in FIG. 1) only monitors a subset of the time duration to be monitored when performing a full sensing procedure. For example, there are two partial sensing windows during the time duration to be monitored when performing a full sensing procedure as shown in FIG. 2, and each partial sensing window is marked as “ON” as shown in FIG. 2. FIG. 2 shows a resource selection time point. Based on the resource selection time, the PUE may select a transmission resource in the time and frequency domains based on the partial sensing procedure as shown in FIG. 2.

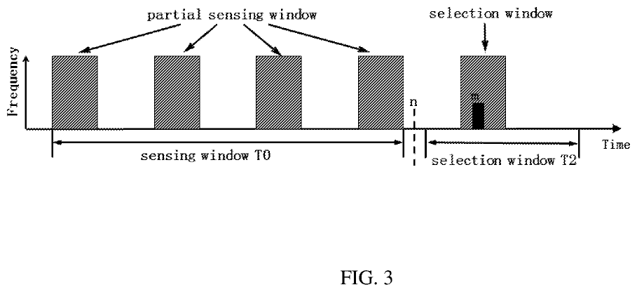

Resource re-evaluation has been introduced in NR V2X Mode 2. Before beginning to use its selected or reserved resources, a sensing UE re-evaluates the selected or reserved resources until a cut-off time before the intended time of transmission, so that the UE can select different resources or drop a transmission on the selected or reserved resources in a case that late-arriving sidelink control information (SCI) is detected which is due, typically, to an aperiodic service starting to transmit after an end of the sensing window. The cut-off time is long enough before transmission to allow the UE to perform the resource re-evaluation procedure. Timeline of a sensing window and timeline of a resource selection or re-selection window with respect to triggering time “n” are shown in FIG. 3.

FIG. 3 illustrates a further exemplary partial sensing procedure in accordance with some embodiments of the present application. The embodiments of FIG. 3 show a partial sensing procedure described in LTE V2X for P-UE according to 3GPP standard document TS36.213. In particular, there are four partial sensing windows in sensing window T0, triggering time “n” is between the sensing window T0 and selection window T2, and the selection window T2 includes resource “m” selected or re-selected based on the triggering time “n”.

Although a specific number of partial sensing windows are depicted in FIG. 3, it is contemplated that any number of partial sensing windows may be included in the sensing window T0 during a partial sensing procedure, and it depends upon specific configuration information for a partial sensing window of the partial sensing procedure. For example, the sensing window T0 as shown in FIG. 3 may only include four partial sensing windows.

Currently, based on an object in new work item description (WID) on sidelink enhancement for 3GPP 5G NR, sidelink resource allocation need to be enhanced by considering power consumption of sidelink communication UEs. To reduce power consumption of a sidelink between UEs in 3GPP 5G NR, a partial sensing procedure is considered to be introduced to sidelink resource allocation Mode 2 of Release 17 of 3GPP 5G NR.

For NR V2X communication system, there are a number of trigger conditions for a resource (re-)selection procedure. One trigger condition is the possibility to configure a resource pool with a pre-emption function that is designed to help accommodate aperiodic sidelink traffic, so that a UE may (re-)select resources which have already been reserved if a nearby UE with a higher priority indicates that the nearby UE is going to transmit a transmission on the selected or reserved resources, which implies that a high-priority aperiodic traffic is going to be transmitted from this nearby UE on the selected or reserved resources.

After a UE performing a resource (re-)selection procedure and using the selected resource to transmit a transmission over a sidelink, the UE should further perform a resource re-evaluation procedure for the selected resource regarding whether the selected resource collides with other UE's transmission(s) that has a higher priority. There is a need to define and configure a resource re-evaluation period to a UE, if a partial sensing procedure is configured to the UE by higher layers.

Some embodiments of the present application provide a method for sidelink resource re-evaluation. Some embodiments of the present application provide a method for sidelink resource (re-)selection. Some embodiments of the present application provide a method for transmitting a sidelink transmission.

Some embodiments of the present application provide an apparatus for sidelink resource re-evaluation. Some embodiments of the present application provide an apparatus for sidelink resource (re-)selection. Some embodiments of the present application provide an apparatus for transmitting a sidelink transmission.

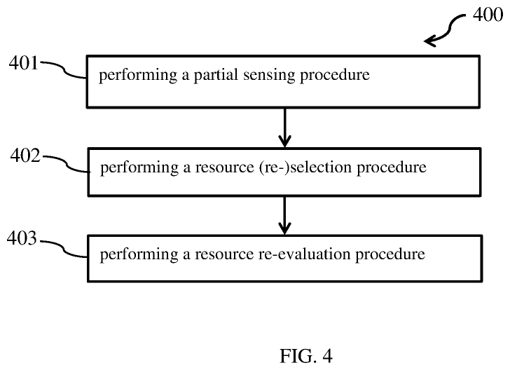

FIG. 4 illustrates an exemplary flow chart of performing a partial sensing procedure in accordance with some embodiments of the present application. The embodiments of FIG. 4 may be performed by a UE (e.g., UE 101a or UE 101b illustrated and shown in FIG. 1), and the UE may be a PUE.

According to the exemplary method 400 as illustrated and shown in FIG. 4, in step 401, a UE (e.g., UE 101a illustrated and shown in FIG. 1) performs a partial sensing procedure. In step 402, the UE performs a resource (re-)selection procedure. In step 403, the UE performs a resource re-evaluation procedure. Details related to the embodiments of FIG. 4 are described in the following paragraphs of the present application.

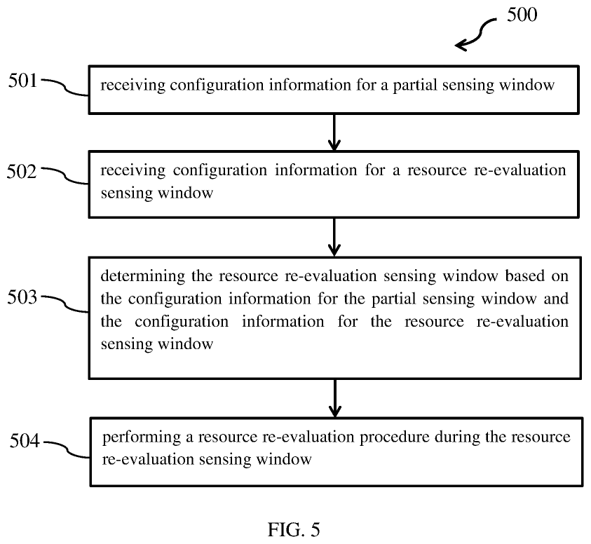

FIG. 5 illustrates an exemplary flow chart of a method for performing a resource re-evaluation procedure in accordance with some embodiments of the present application. The embodiments of FIG. 5 may be performed by a UE (e.g., UE 101a or UE 101b illustrated and shown in FIG. 1), and the UE may be a PUE.

According to the exemplary method 500 as illustrated and shown in FIG. 5, in step 501, a UE receives configuration information for a partial sensing window. From a prospective of a subsequent partial sensing procedure, a selection window, e.g., the selection window T2 as shown in FIG. 3, may be named as a partial sensing window.

For example, with reference to the embodiments of FIG. 3, configuration information for a partial sensing window received in step 501 may include configuration information for any partial sensing window in the sensing window T0 as shown in FIG. 3 and/or configuration information for the selection window T2 as shown in FIG. 3.

In some embodiments of the present application, the UE determines a resource selection window based on the received configuration information for the partial sensing window. The UE may determine a limited resource selection window based on a time offset and a starting time of a partial sensing window or a selection window. This time offset may be configured by RRC signaling. This time offset may be configured per resource pool. A specific example may refer to embodiments of FIG. 10.

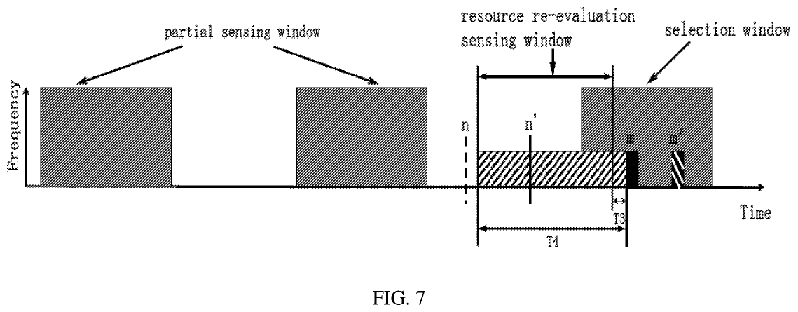

In step 502, the UE receives configuration information for a resource re-evaluation sensing window. In one example, the configuration information for the resource re-evaluation sensing window may include a time offset. In another example, the configuration information for the resource re-evaluation sensing window may include a size of the resource re-evaluation sensing window. Specific examples may refer to embodiments of FIGS. 7-9.

In step 503, the UE determines the resource re-evaluation sensing window based on the configuration information for the partial sensing window and the configuration information for the resource re-evaluation sensing window. Specifically, the UE determines a start point and an end point of the resource re-evaluation sensing window in a time domain in step 503.

In step 504, the UE performs a resource re-evaluation procedure during the resource re-evaluation sensing window. In some embodiments of the present application, the resource re-evaluation procedure is performed after the UE finishing the resource (re-)selection procedure.

In some embodiments of the present application, the UE performs a resource (re-)selection procedure during the resource re-evaluation sensing window which is determined in step 503, to (re-)select a resource. The resource (re-)selected by the resource (re-)selection procedure may be based on the partial sensing window. The resource (re-)selected by the resource (re-)selection procedure may be in a selection window (e.g., a selection window T2 as shown in FIG. 3).

In some embodiments of the present application, the resource re-evaluation procedure ends earlier than an end time of the resource re-evaluation sensing window by a processing time offset (e.g., value of T3 as shown in FIGS. 7-9). Specific examples may refer to embodiments of FIGS. 7-9.

In some embodiments of the present application, the resource re-evaluation procedure starts from a starting time of the resource re-evaluation sensing window. In an example, the starting time of the resource re-evaluation sensing window may be determined based on a starting time of the partial sensing window.

In a further example, the starting time of the resource re-evaluation sensing window may be determined based on a size of the resource re-evaluation sensing window.

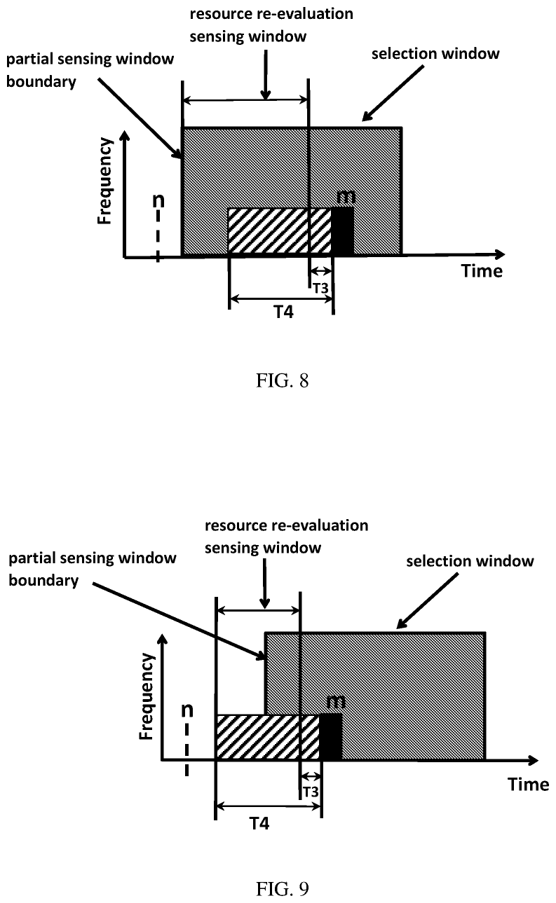

In another example, the starting time of the resource re-evaluation sensing window is determined based on an earlier time within a starting time of the partial sensing window and a starting time of a size of the resource re-evaluation sensing window. Specific examples may refer to embodiments of FIGS. 8 and 9.

In some embodiments of the present application, the configuration information for the resource re-evaluation sensing window (e.g., a size of the resource re-evaluation sensing window) is configured by radio resource control (RRC) signaling.

In an embodiment of the present application, the UE may be configured by RRC signaling from a network, and the RRC signaling includes configuration information for a partial sensing window and/or configuration information for a resource re-evaluation sensing window. Specific examples may refer to embodiments of FIGS. 7-9).

For example, the RRC signaling from a BS includes a resource re-evaluation sensing window size. For instance, the RRC signaling may be of the following format:

| | |
|---|---|
| p2x-SensingConfig-r17 | SEQUENCE { |

resource re-evaluation sensing window INTEGER (3ms, 5ms, 10ms,
20ms, 50ms, 100ms...)
}

In some other embodiments of the present application, the configuration information for the resource re-evaluation sensing window (e.g., a size of the resource re-evaluation sensing window) is pre-configured for the UE, and in these embodiments, the UE will perform the exemplary method 500 without the operation in step 502. That is to say, the UE performs a resource re-evaluation procedure during the resource re-evaluation sensing window which has the pre-configured resource re-evaluation sensing window size.

The resource re-evaluation behaviour for the UE performing a partial sensing procedure may be configured per a resource pool. The configuration information for the resource re-evaluation sensing window (e.g., a size of the resource re-evaluation sensing window) may be configured per a resource pool.

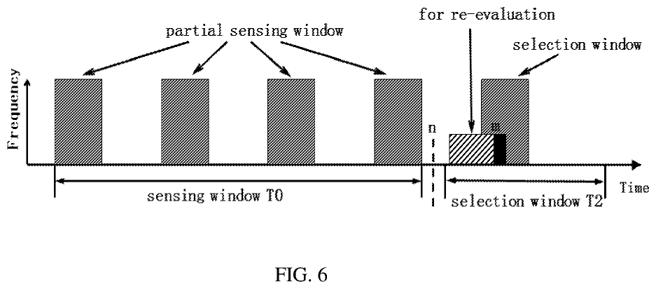

FIG. 6 illustrates another exemplary partial sensing procedure in accordance with some embodiments of the present application. The embodiments of FIG. 6 have similar configurations to those for the embodiments of FIG. 3, except defining a resource re-evaluation sensing window, which is marked as “for re-evaluation” as shown in FIG. 6.

A UE may perform a resource re-evaluation procedure in the resource re-evaluation sensing window. For example, a UE who is configured by higher layers may perform a resource re-evaluation procedure in the resource re-evaluation sensing window. The resource re-evaluation sensing window may be activated or used, when the UE has finished its resource (re-)selection procedure (e.g., at time point “n” as shown in FIG. 6). The UE may additionally perform a subsequent partial sensing procedure during the selection window that is also a partial sensing window from a perspective of the subsequent partial sensing procedure. Embodiments of the present application aim to provide solutions of how to design a resource re-evaluation sensing window.

FIG. 7 illustrates an additional exemplary partial sensing procedure in accordance with some embodiments of the present application. The embodiments of FIG. 7 have similar configurations to those for the embodiments of FIG. 6, except that there are two partial sensing windows in FIG. 7.

In the embodiments of FIG. 7, if the (re-)selected resource (e.g., at time point “m” within the selection window as shown in FIG. 6) is pre-empted by others UE(s) or collides with others UE(s), the UE will perform a resource (re-)selection procedure (e.g., at time point “n” as shown in FIG. 6). For example, a resource (re-)selected by the resource (re-)selection procedure is at time point “m” in the selection window as shown in FIG. 7. The time point “m” may be earlier than the time point “m”, later than the time point “m”, or even in the same slot as the time point “m”.

The embodiments of FIG. 7 define a time offset for a resource re-evaluation sensing window (i.e., T4 as shown in FIG. 7) before the (re-)selected resource in the selection window which is shown at time point “m” in FIG. 7. T4 is of a value greater or equal to 0. T4 may also be named as a resource re-evaluation sensing window size.

Specifically, for a UE, if configuration information for a partial sensing window is configured by higher layers, the UE may re-evaluate the (re-)selected or reserved resource after the resource re-evaluation window, and the resource re-evaluation window starts at time instance (m−T4) and ends at time instance (m-T3). T3 is a resource re-evaluation processing time of the UE and depends upon the UE's processing capability. In short, the resource re-evaluation window lasts from (m− T4) until (m− T3) in the time domain. The length of the resource re-evaluation window is (T4-T3).

According to some embodiments of the present application, a resource re-evaluation processing time of a UE (e.g., T3 as show in FIG. 7) may not be used to determine a staring time and ending time of a resource re-evaluation sensing window. In these embodiments, the length of a resource re-evaluation window is a time offset or size configured for the resource re-evaluation sensing window (e.g., T4 as shown in FIG. 7) before the (re-)selected resource in the selection window (e.g., at time point “m” in FIG. 7). For example, without considering the resource re-evaluation processing time of a UE (e.g., T3 as show in FIG. 7), the resource re-evaluation window lasts from (m− T4) until “m” in the time domain.

Details described in the embodiments as illustrated and shown in FIG. 1-5, especially, contents related to a resource re-evaluation sensing window, are applicable for the embodiments as illustrated and shown in FIG. 7. Moreover, details described in the embodiments of FIG. 7 are applicable for all the embodiments of FIGS. 1-6 and 8-13.

According to some embodiments of the present application, a UE performing a partial sensing procedure may determine the starting point of a resource re-evaluation sensing window based on the configured resource re-evaluation sensing window size (e.g., T4) and a partial sensing window. For example, based on the (re-)selected resource at time point “m” in a selection window, the UE may (re-)select an earlier time point from “a boundary determined by the configured resource re-evaluation sensing window size” and “a partial sensing window boundary”, as a boundary of the resource re-evaluation sensing window. Specific examples may refer to embodiments of FIGS. 8 and 9.

According to some embodiments of the present application, the length of a resource re-evaluation sensing window can be configured to use one of “configured resource re-evaluation sensing window size (T4)” and “a partial sensing window boundary” per a resource pool.

FIG. 8 illustrates an exemplary resource re-evaluation procedure in accordance with some embodiments of the present application. Elements in the embodiments of FIG. 8 (e.g., “m”, “n”, and a selection window) have the same meanings as those in FIGS. 3, 6, and 7.

In the embodiments of FIG. 8, a resource re-evaluation sensing window size for a UE is configured as T4 as shown in FIG. 8. A partial sensing window boundary is earlier than a boundary determined by the configured resource re-evaluation sensing window size T4 as show in FIG. 8. Thus, the UE may select a partial sensing window boundary, as a boundary of the resource re-evaluation sensing window. That is to say, in the embodiments of FIG. 8, the resource re-evaluation window for the UE lasts from the partial sensing window boundary until (m− T3) in the time domain. The length of the resource re-evaluation window is greater than T4, and is also greater than (T4-T3). T3 is a resource re-evaluation processing time of the UE.

According to some embodiments of the present application, a resource re-evaluation processing time of the UE (e.g., T3 as shown in FIG. 8) is not used to determine a staring time and ending time of a resource re-evaluation sensing window. For example, without considering the resource re-evaluation processing time of a UE (e.g., T3 as show in FIG. 8), the resource re-evaluation window lasts from the partial sensing window boundary until a starting time of the (re-)selected resource in a selection window (e.g., at time point “m” in FIG. 8) in the time domain.

FIG. 9 illustrates a further exemplary resource re-evaluation procedure in accordance with some embodiments of the present application. Elements in the embodiments of FIG. 9 (e.g., “m”, “n”, and a selection window) have the same meanings as those in FIGS. 3 and 6-8.

In the embodiments of FIG. 9, a resource re-evaluation sensing window size for a UE is configured as T4 as shown in FIG. 9. A boundary determined by the configured resource re-evaluation sensing window size T4 as show in FIG. 9 is earlier than a partial sensing window boundary. Thus, the UE may determine the starting point of resource re-evaluation sensing window based on the configured resource re-evaluation sensing window size T4, as a boundary of the resource re-evaluation sensing window. That is to say, in the embodiments of FIG. 9, the resource re-evaluation window for the UE lasts from (m− T4) until (m− T3) in the time domain. The length of the resource re-evaluation window is (T4-T3). T3 is a resource re-evaluation processing time of the UE.

According to some embodiments of the present application, a resource re-evaluation processing time of the UE (e.g., T3 as shown in FIG. 9) is not used to determine a staring time and ending time of a resource re-evaluation sensing window. For example, without considering the resource re-evaluation processing time of a UE (e.g., T3 as show in FIG. 9), the resource re-evaluation window lasts from (m− T4) until “m” as show in in FIG. 9 in the time domain.

FIG. 10 illustrates an exemplary resource selection procedure in accordance with some embodiments of the present application. Elements in the embodiments of FIG. 10 (e.g., “m” and a selection window) have the same meanings as those in FIGS. 3 and 6-9.

The embodiments of FIG. 10 provide a solution to determine a starting point of a limited resource selection window for a UE. In particular, a time offset value T5 is configured for a UE, and the selected resource in a selection window should be limited after a time point (a selection window boundary+T5+T3). T3 is a resource re-evaluation processing time of the UE. T5 may be configured per resource pool or not. That is to say, the starting point of a limited resource selection window for the UE is a time point (a selection window boundary+T5+T3) in the time domain, and the ending time of the limited resource selection window for the UE is the end time of the selection window.

According to some embodiments of the present application, if a Tx UE with a higher priority traffic (transmission) selects a resource indicated or reserved by another UE performing a partial sensing procedure, the Tx UE should send a transmission or a pre-emption indicator after a calculated time slot but before the resource indicated or reserved by the UE performing the partial sensing procedure. For example, the earliest calculated time slot may be calculated by substrating a time offset from a (re-)selected resource in a selection window (e.g., at time point “m” in FIGS. 3-11). The time offset may be (pre-)configured. For example, the time offset is (pre-)configured per a resource pool.

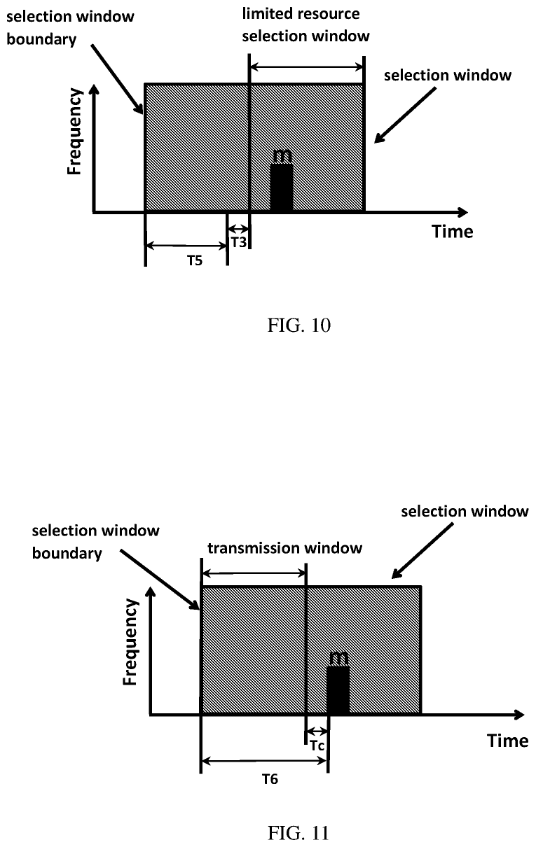

These embodiment ensure that the Tx UE sends a transmission or a pre-emption indicator in a transmission window. A size of the transmission window may be configured. For example, the size of the transmission window may be configured per a resource pool. Upon detecting a transmission or a pre-emption indicator in the transmission window, the UE performing the partial sensing procedure can drop the transmission with a lower priority. Specific examples may refer to embodiments of FIG. 11.

FIG. 11 illustrates an exemplary resource transmission procedure in accordance with some embodiments of the present application. Elements in the embodiments of FIG. 11 (e.g., “m” and a selection window) have the same meanings as those in FIGS. 3 and 6-10.

The embodiments of FIG. 11 provide a solution to determine a starting point and an ending point of a transmission window for a Tx UE. In particular, a time offset value T6 and a common resource processing time of a UE Tc are configured for a Tx UE. T6 and Tc may be configured per a resource pool or not. That is to say, the starting point of a transmission window for the Tx UE is a time point (m− T6) in the time domain, and the ending time of the transmission window for the Tx UE is (m− Tc) in the time domain.

According to some embodiments of the present application, a common resource processing time of a UE (e.g., Tc as shown in FIG. 11) is not used to determine a staring time and an ending time of a transmission window. For example, without considering the common resource processing time of a UE (e.g., Tc as show in FIG. 11), the transmission window lasts from (m— T6) until “m” as show in in FIG. 11 in the time domain.

Details described in the embodiments as illustrated and shown in FIG. 1-5, especially, contents related to a resource re-evaluation sensing window, are applicable for the embodiments as illustrated and shown in any one of FIGS. 8-11. Moreover, details described in the embodiments of FIGS. 8-11 are applicable for all the embodiments of FIGS. 1-7, 12, and 13.

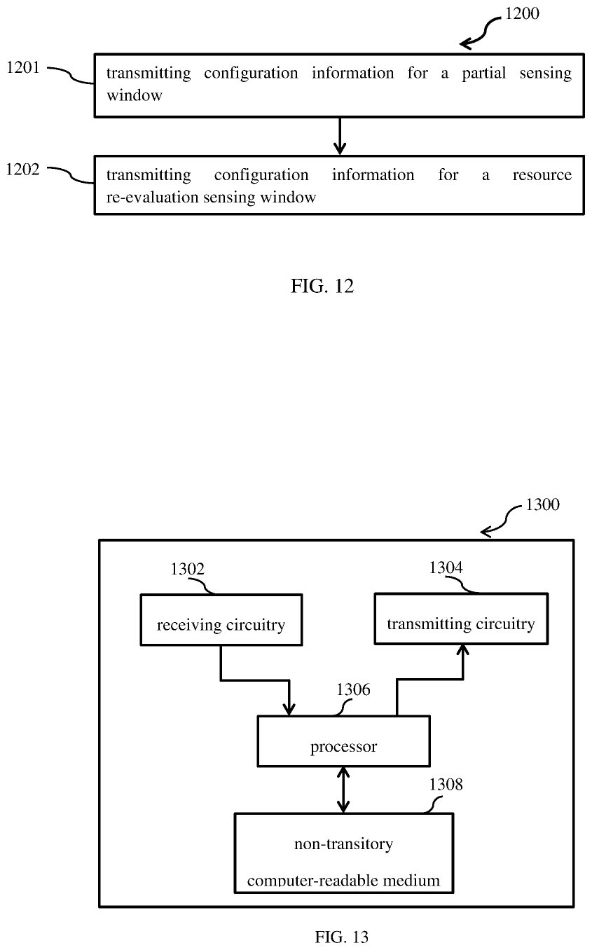

FIG. 12 illustrates a further exemplary flow chart of a method for wireless communication in accordance with some embodiments of the present application. The embodiments of FIG. 12 may be performed by a network (e.g., network 102 as shown in FIG. 1).

According to the exemplary method 1200 as illustrated and shown in FIG. 12, in step 1201, a network transmits configuration information for a partial sensing window. In step 1202, the network transmits configuration information for a resource re-evaluation sensing window. The transmitted configuration information for the partial sensing window and the transmitted configuration information for the resource re-evaluation sensing window may be used for determining the resource re-evaluation sensing window.

Details described in the embodiments as illustrated and shown in FIGS. 2-11, especially, contents related to a resource re-evaluation sensing window, are applicable for the embodiments as illustrated and shown in FIG. 12. Moreover, details described in the embodiments of FIG. 12 are applicable for all the embodiments of FIGS. 1-11 and 13.

FIG. 13 illustrates a block diagram of an exemplary apparatus in accordance with some embodiments of the present application. Referring to FIG. 13, the apparatus 1300 includes a receiving circuitry 1302, a transmitting circuitry 1304, a processor 1306, and a non-transitory computer-readable medium 1308. The processor 1306 is coupled to the non-transitory computer-readable medium 1308, the receiving circuitry 1302, and the transmitting circuitry 1304.

It is contemplated that some components are omitted in FIG. 13 for simplicity. In some embodiments, the receiving circuitry 1302 and the transmitting circuitry 1304 may be integrated into a single component (e.g., a transceiver).

In some embodiments, the non-transitory computer-readable medium 1308 may have stored thereon computer-executable instructions to cause a processor to implement the operations with respect to UE(s) as described above. For example, upon execution of the computer-executable instructions stored in the non-transitory computer-readable medium 1308, the processor 1306, and the receiving circuitry 1302 perform the method of FIG. 5, including: the receiving circuitry 1302 receives configuration information for a partial sensing window; the receiving circuitry 1302 receives configuration information for a resource re-evaluation sensing window; the processor 1306 determines the resource re-evaluation sensing window based on the configuration information for the partial sensing window and the configuration information for the resource re-evaluation sensing window; and the processor 1306 performs a resource re-evaluation procedure during the resource re-evaluation sensing window.

In some embodiments, the non-transitory computer-readable medium 1308 may have stored thereon computer-executable instructions to cause a processor to implement the operations with respect to BS(s) as described above. For example, upon execution of the computer-executable instructions stored in the non-transitory computer-readable medium 1308, the processor 1306 and the transmitting circuitry 1304 perform the method of FIG. 12, including: the transmitting circuitry 1304 transmits configuration information for a partial sensing window; and the transmitting circuitry 1304 transmits configuration information for a resource re-evaluation sensing window, wherein the configuration information for the partial sensing window and the configuration information for the resource re-evaluation sensing window are used for determining the resource re-evaluation sensing window.

The method of the present application can be implemented on a programmed processor. However, the controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device on which there resides a finite state machine capable of implementing the flowcharts shown in the figures may be used to implement the processor functions of the present application.

Those having ordinary skills in the art would understand that the steps of a method described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. Additionally, in some aspects, the steps of a method may reside as one or any combination or set of codes and/or instructions on a non-transitory computer-readable medium, which may be incorporated into a computer program product.

While this disclosure has been described with specific embodiments thereof, it is evident that many alternatives, modifications, and variations may be apparent to those skilled in the art. For example, various components of the embodiments may be interchanged, added, or substituted in the other embodiments. Also, all the elements of each figure are not necessary for operation of the disclosed embodiments. For example, one of ordinary skill in the art of the disclosed embodiments would be enabled to make and use the teachings of the disclosure by simply employing the elements of the independent claims. Accordingly, embodiments of the disclosure as set forth herein are intended to be illustrative, not limiting. Various changes may be made without departing from the spirit and scope of the disclosure.

In this document, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that comprises the element. Also, the term “another” is defined as at least a second or more. The terms “including,” “having,” and the like, as used herein, are defined as “comprising.”

1. A method for sidelink communications performed by a user equipment (UE), comprising:
receiving first configuration information for a partial sensing window;
receiving second configuration information for a resource re-evaluation sensing window;
determining the resource re-evaluation sensing window based on the first configuration information for the partial sensing window and the second configuration information for the resource re-evaluation sensing window; and
performing a resource re-evaluation procedure during the resource re-evaluation sensing window.

2. The method of claim 1, further comprising:
performing a resource selection procedure or a resource re-selection procedure; and
performing the resource re-evaluation procedure after finishing the resource selection procedure or the resource re-selection procedure.

3. The method of claim 1, further comprising:
performing a resource selection procedure or a resource re-selection procedure during the resource re-evaluation sensing window, to select or re-select a resource.

4. The method of claim 3, wherein the resource selected by the resource selection procedure or the resource re-selected by the resource re-selection procedure is based on the partial sensing window.

5. The method of claim 1, wherein the second configuration information for the resource re-evaluation sensing window includes at least one of a first time offset or a size of the resource re-evaluation sensing window.

6-8. (canceled)

9. The method of claim 1, wherein the resource re-evaluation procedure ends earlier than an end time of the resource re-evaluation sensing window by a processing time offset.

10. The method of claim 1, wherein the resource re-evaluation procedure starts from a starting time of the resource re-evaluation sensing window.

11-35. (canceled)

36. An apparatus, comprising:
a receiving circuitry;
a transmitting circuitry; and
a processor coupled to the receiving circuitry and the transmitting circuitry configured to:
receive first configuration information for a partial sensing window;
receive second configuration information for a resource re-evaluation sensing window;
determine the resource re-evaluation sensing window based on the first configuration information for the partial sensing window and the second configuration information for the resource re-evaluation sensing window; and
perform a resource re-evaluation procedure during the resource re-evaluation sensing window.

37. An apparatus, comprising:
a receiving circuitry;
a transmitting circuitry; and
a processor coupled to the receiving circuitry and the transmitting circuitry configured to:
transmit first configuration information for a partial sensing window; and
transmit second configuration information for a resource re-evaluation sensing window, the first configuration information for the partial sensing window and the second configuration information for the resource re-evaluation sensing window usable for a determination of the resource re-evaluation sensing window.

38. The apparatus of claim 37, wherein a resource selection procedure or a resource re-selection procedure is performed during the resource re-evaluation sensing window, to re-select a resource.

39. The apparatus of claim 38, wherein the resource selected by the resource selection procedure or the resource re-selected by the resource re-selection procedure is based on the partial sensing window.

40. The apparatus of claim 37, wherein the second configuration information for the resource re-evaluation sensing window includes at least one of a first time offset or a size of the resource re-evaluation sensing window.

41. The apparatus of claim 37, wherein a resource re-evaluation procedure is performed during the resource re-evaluation sensing window.

42. The apparatus of claim 41, wherein the resource re-evaluation procedure ends earlier than an end time of the resource re-evaluation sensing window by a processing time offset.

43. The apparatus of claim 36, wherein the processor coupled to the receiving circuitry and the transmitting circuitry are configured to:
perform a resource selection procedure or a resource re-selection procedure; and
perform the resource re-evaluation procedure after finishing the resource selection procedure or the resource re-selection procedure.

44. The apparatus of claim 36, wherein the processor coupled to the receiving circuitry and the transmitting circuitry are configured to perform a resource selection procedure or a resource re-selection procedure during the resource re-evaluation sensing window, to select or re-select a resource.

45. The apparatus of claim 44, wherein the resource selected by the resource selection procedure or the resource re-selected by the resource re-selection procedure is based on the partial sensing window.

46. The apparatus of claim 36, wherein the second configuration information for the resource re-evaluation sensing window includes at least one or more of a first time offset, or a size of the resource re-evaluation sensing window.

47. The apparatus of claim 36, wherein the resource re-evaluation procedure ends earlier than an end time of the resource re-evaluation sensing window by a processing time offset.

48. The apparatus of claim 36, wherein the resource re-evaluation procedure starts from a starting time of the resource re-evaluation sensing window.
